(19) United States
(12) Patent Application Publication
(10) Pub. No.: US 2016/0168436 A1
(43) Pub. Date: Jun. 16, 2016

(54) ENTROPICALLY STABILIZED IONIC AND PARTIALLY IONIC COMPOUNDS AND RELATED METHODS

(71) Applicant: North Carolina State University, Raleigh, NC (US)

(72) Inventors: Jon-Paul Maria, Raleigh, NC (US); Elizabeth Dickey, Raleigh, NC (US); Trent Borman, Raleigh, NC (US)

(21) Appl. No.: 14/967,938

(22) Filed: Dec. 14, 2015

Related U.S. Application Data
(60) Provisional application No. 62/091,300, filed on Dec. 12, 2014.

(51) Int. Cl. C09K 3/00

(52) U.S. Cl. CPC C09K 3/00

(57) ABSTRACT

An equimolar formulation of three or more ionic or partially ionic compounds stabilized by configurational entropy into a homogeneous crystal is provided.

### BACKGROUND

Strategies to understand and create new substances began with macroscopic observations in the mineral world. 20th century advances in characterization revealed quantitative connections linking crystal structure, composition, and microstructure to physical properties. With this information artificial materials could be rationally designed to address specific technology needs. Examples with profound technological impact include high strength steels, permanent magnets, modern dielectrics, and glass fibers. In the mid-20th century attentions turned towards extremely pure and homogeneous semiconductors, and the ability manipulate charge carriers at their surfaces and interfaces. This triggered an era of microelectronic devices that displaced and miniaturized numerous conventional technologies. In the 1990s, researchers began to explore confined geometries, quantized phenomena, and materials with high interface- to-volume ratios. These efforts produced new abilities to functionalize surfaces, to deliver medicine, and to harvest light following a nanoscience paradigm.

Advances in property engineering remain rapid, but they result increasingly from optimizing existing materials and refining synthesis. For example: today's premier high permittivity dielectric, BaTiO₃, was discovered in 1955 (Von Hippel, A., Breckenridge, R. G., Chesley, F. G. & Tisza, L. High dielectric constant ceramics. Industrial & Engineering Chemistry 38, 1097-1109 (1946)); Ni-superalloys were first developed in 1941 (Smith, W. F. Structure and Properties of Engineering Alloys. (McGraw-Hill, 1993)); and the first GaN blue light emitting diode was demonstrated in 1989 (Amano, H., Kita, M., Hiramatsu, K. & Akasaki, P-Type Conduction in Mg-Doped GaN Treated with Low-Energy Electron Beam Irradiation (LEEBI). Jpn. J. Appl. Phys. 28, L2112 (1989)).

Tremendous strides in materials technology continue to occur. However, discovery of wholly new materials infrequently drives such advances. In response to this situation large programs like the Materials Genome Initiative have emerged, with a mandate to identify attractive new candidates, and to expedite their implementation.

The inventors of the subject matter presently disclosed herein disclose that new materials development is modest because (given practical restrictions including toxicity, scarcity, radioactivity, etc.) most crystalline solids that are stable under ambient conditions are already known. As such, investigating alternative scenarios for stabilization is a sensible thesis.

One possibility exploits entropic stabilization. Disorder can be engineered via composition and amplified by temperature provided many distinct ions can be distributed within a common crystalline sublattice. The large number of equivalent and distinct configurations will create populations of microstates. By virtue of their numbers these state are more favorable than an alternative multiphase assembly.

There are observations for such behavior in metallic alloys (Cantor, B., Chang, I. T. H., Knight, P. & Vincent, A. J. B. Microstructural development in equiatomic multicomponent alloys. Mater. Sci. Eng. A-Struct. Mater. Prop. Microstruct. Process. 375, 213-218 (2004); Yeh, J. W. et al. Nanostructured high-entropy alloys with multiple principal elements: Novel alloy design concepts and outcomes. Adv. Eng. Mater. 6, 299-303 (2004); Zhang, Y., Zhou, Y. J., Lin, J. P., Chen, G. L. & Liaw, P. K. Solid-solution phase formation rules for multi-component alloys. Adv. Eng. Mater. 10, 534-538 (2008)), but uncertainty remains regarding phase-purity. Currently a productive discussion regarding the explicit role of configurational entropy continues. See Jones, N. G., Aveson, J. W., Bhowmik, A., Conduit, B. D. & Stone, H. J. On the entropic stabilization of an Al0.5CrFeCoNiCu high entropy alloy. Intermetallics 54, 148-153 (2014); Otto, F., Yang, Y., Bei, H. & George, E. P. Relative effects of enthalpy and entropy on the phase stability of equiatomic high-entropy alloys. Acta Mater. 61, 2628-2638 (2013); Wu, Z., Bei, H., Otto, F., Pharr, G. M. & George, E. P. Recovery, recrystallization, grain growth and phase stability of a family of FCC-structured multi-component equiatomic solid solution alloys. Intermetallics 46, 131-140 (2014); and Zhang, F. et al. An understanding of high entropy alloys from phase diagram calculations. Calphad-Comput. Coupling Ph. Diagrams Thermochem. 45, 1-10 (2014).

### SUMMARY

To address the foregoing problems, in whole or in part, and/or other problems that may have been observed by persons skilled in the art, the present disclosure provides methods, processes, systems, apparatus, instruments, and/or devices, as described by way of example in implementations set forth below.

According to an embodiment, an equimolar formulation of three or more ionic or partially ionic compounds stabilized by configurational entropy into a homogeneous crystal is provided.

According to another embodiment, the three or more ionic or partially ionic compounds comprise binary compounds, tertiary compounds, and/or quaternary compounds.

According to another embodiment, the equimolar formulation comprises five or more ionic or partially ionic compounds.

According to another embodiment, the ionic or partially ionic compounds comprise oxides and/or nitrides.

According to another embodiment, the binary oxides comprise at least one of: magnesium oxide (MgO), cobalt oxide (CoO), nickel oxide (NiO), copper oxide (CuO), zinc oxide (ZnO), iron oxide (Fe₂O₃), and titanium oxide (TiO₂).

According to another embodiment, the equimolar formulation is a single-phase solid solution.

Other devices, apparatus, systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The invention can be better understood by referring to the following figures. The components in the figures are not necessarily to scale, emphasis instead being placed upon illustrating the principles of the invention. In the figures, like reference numerals designate corresponding parts throughout the different views.

FIG. 1 is a set of X-ray diffraction patterns for high entropy formulation J14, an equimolar mixture of MgO, NiO, ZnO, CuO, and CoO; the patterns were collected from a single pellet equilibrated for 2 hours at each temperature in air, then air quenched to room temperature by direct extraction from the furnace; X-ray intensity is plotted on a logarithmic scale and arrows indicate peaks associated with non-rocksalt phases.

FIG. 2 shows an X-ray diffraction analysis for a composition series where individual components are removed from the parent composition J14 and heat-treated to the conditions that would otherwise produce full solid solution; asterisks identify peaks from rocksalt while carets identify peaks from other crystal structures.

FIG. 3, graph (a) illustrates calculated configurational entropy in an N-component solid solution as a function of Mol % of the Nth component. Graphs (b)-(f) are partial phase diagrams showing the transition temperature to single phase as a function of composition in the vicinity of the equimolar composition where maximum configurational entropy is expected; each phase diagram varies systematically the concentration of one element.

FIG. 4 shows in situ x-ray diffraction analysis and differential scanning calorimetry trace for alloy J14. Note that the conversion to single phase is accompanied by an endotherm.

FIG. 5 shows an XAFS analysis for Zn, Ni, Cu, and Co in J14; the metal-oxygen bond lengths for all species are identical to within experimental error; this result is consistent with random occupancy of the cation sublattice and a uniform oxygen sublattice.

FIG. 6 shows an STEM-EDS analysis for alloy J14. Image (a) is a HAADF image while images (b-f) are individual maps for Zn, Ni, Cu, Mg and Co. All maps indicate uniform distribution of the individual species.

FIG. 7 is a schematic illustration highlighting the first near-neighbor environments of a random two component metal alloy (schematic a), and a random two component mixed oxide where cation-cation interactions are screened by the oxygen sublattice (schematic b).

### DETAILED DESCRIPTION

The present disclosure demonstrates unambiguous experimental evidence for true entropic stabilization in a crystalline alloy and presents a thermodynamic explanation for the composition trends. Furthermore, the present disclosure proposes that entropy stabilization is fundamentally more effective in a complex oxide (and other ionic and partially ionic compounds) due to anion screening.

These experiments and observations lead to profound conclusions: 1) a truly new family of crystalline oxides (and other ionic and partially ionic compounds) await discovery; 2) the number of new compositions are potentially large; and 3) transition metal cations (the cornerstones of functionality in many oxides and other ionic and partially ionic compounds) can be incorporated into a crystal sublattice in completely new ways. Consequently, transformative opportunities for new advanced materials with novel properties and functionality await discovery.

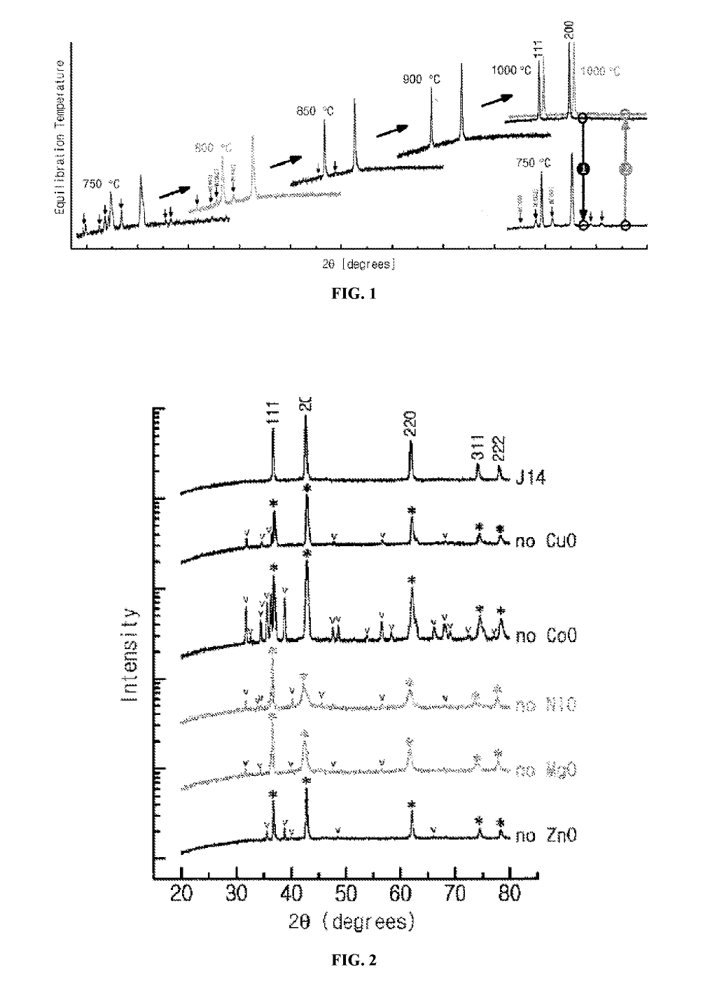

The entropic stabilization hypothesis was tested for a mixture of five binary oxide compounds using conventional powder processing methods. The primary candidate in the present example is an equimolar mixture of MgO, CoO, NiO, CuO, and ZnO, which is referred to herein as “formulation J14.” These component oxides were chosen because they provide a substantial diversity in their crystal structures, preferred coordination, and cationic radii. The diversity within this group of binary oxides is deliberately large as this best demonstrates the entropic influence. In the initial experiment, equimolar formulations were equilibrated in an air furnace over a temperature ladder spanning 700 to 1100° C. in 100° C. increments. The samples were extracted from the furnace and air-quenched to room temperature in less than 1 min. Phase evolution was determined by x-ray diffraction. Samples were massed before and after each heat treatment, no significant changes were observed. X-ray diffraction (XRD) patterns for this first sample set are shown in FIG. 1. Above a 700° C. equilibration, two prominent phases are observed, rocksalt and wurtzite.

With increasing equilibration temperature the wurtzite phase fraction falls, and full conversion to single phase rocksalt occurs between 850° C. and 900° C. It is noted that all x-ray data shown here are plotted on a logarithmic scale and were collected using substantial counting times to scrutinize samples for secondary phases. To the extent knowable using a laboratory diffractometer, the samples are phase pure; there are no additional minor peaks, the background is low and flat, and peak widths are sharp in two-theta space.

At this point, one cannot distinguish between an entropic or enthalpic driving force for solubility. It is conceivable that a line compound exists at the equimolar composition and a 1000° C. anneal is required to reach the equilibrium phase. However, a requisite feature of an entropy-driven transition is reversibility, i.e., one can achieve full solubility upon heating above a temperature threshold, then return to a multi-phase state upon cooling. This possibility was tested by taking the 1000° C. equilibrated sample and re-annealing at 750° C. for 2 hours. This powder pattern, also shown in FIG. 1, reveals the recurrence of the wurtzite second phase. The same sample was reheated to 1000° C. for 2 hours. After reheating it returned to single phase, showing that the transition is enantiotropic.

This observed reversibility is consistent with, but not conclusive of an entropy-driven transition. If entropy is indeed the driving force for solubility there are specific composition trends that must apply. Most importantly, any deviation from the equimolar composition (where mol fraction of all components is 0.2) reduces the number of possible configurations (S_{config}) and increases the temperature needed for full solubility. This is consistent with Gibbs free energy where:

G=H−T(S_{vib}+S_{config})

If ΔH and ΔS_{vib} are not strong functions of composition, any reduction of ΔS_{config}, will increase the transition temperature.

This relationship was explored initially with the n−1 experiment, where five subsidiary formulations were made, each had one component subtracted from the parent mixture. This set of samples was fired at 875° C. for 12 hours. 875° C. was identified by calorimetry as the threshold temperature for complete solubility. The 12-hour anneal was used to ensure sufficient time to approach equilibrium. FIG. 2 shows the x-ray powder patterns for this series. For each instance where a component oxide is removed, the resulting material contains multiple phases. It is interesting to note that for the n−1 samples from which NiO and MgO were removed, the peaks from second phases are very small, and the rocksalt peaks are broad. In addition, the relative intensities change substantially. In these samples, the intensity ratio I₍₂₀₀₎/I₍₁₁₁₎ is less than unity, which is not possible for the rocksalt structure. This ratio change is likely caused by inhomogeneous distributions of cations on the sublattice. These in turn change the local scattering factors.

This result is consistent with the entropy-stabilization hypothesis, especially considering the consistency for all constituents. However, since the enthalpy landscape spanning composition is not known, a more rigorous evaluation is needed. To do so, five sample sets were prepared. In each set the composition of a single component was varied about the equimolar composition to systematically control the configurational entropy. If the materials are entropy-stabilized, the transition temperature to single phase should increase smoothly as the configurations are reduced.

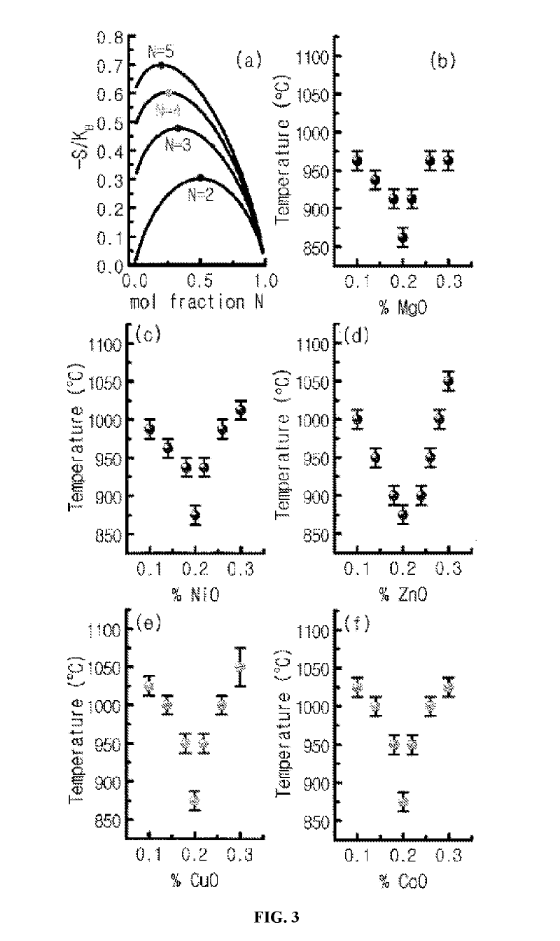

For an ideal and random mixture the dependence of configurational entropy on composition of a single component is plotted in FIG. 3, graph (a), where N defines the number of unique components. The “mole fraction of N” defines its concentration relative to an equimolar matrix of (N−1) components. For example, the “N=5” curve corresponds to an equimolar mixture of 4 unique atoms to which a fifth component is added. When N=0.2, all species are in equal quantity and the system has the maximum configurational entropy.

Annealing temperature ladders and XRD scans were used to determine the minimum temperature needed to achieve single-phase equilibrium for each composition. FIG. 3 summarizes the analysis of 35 samples. Each was equilibrated and quenched in 25° C. intervals between 825° C. and 1125° C. to obtain individual plots of Ttrans vs. composition. In every case, the equimolar composition offered the lowest temperature conversion to single phase, where the largest number of configurations must exist.

The combination of a reversible transformation between single and multiphase states and a compositionally dependent transformation temperature are unambiguous indicators of a configurational-entropy driven process. If so, the phase transition should exhibit an unusual thermodynamic characteristic: the excursion from poly-phase to single-phase should be endothermic. The formation of intermediate crystalline compounds in a multicomponent system is often driven by an exothermic chemical reaction. In an entropy-driven process, the transition is more similar to melting. In this case, however, disorder stems from complete randomization of cations among a single sublattice. This process requires adding heat to the system.

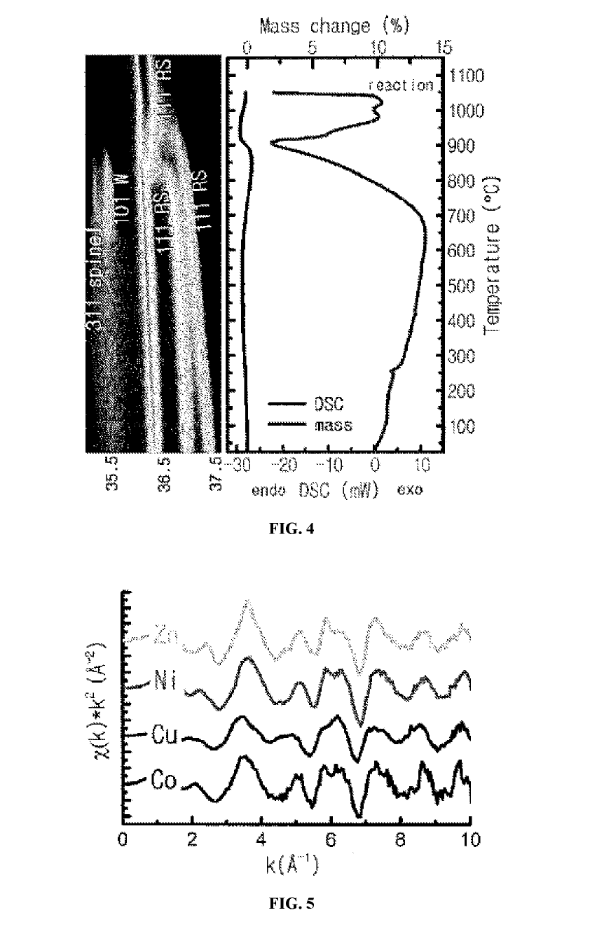

To test this possibility, the phase transformation in alloy J14 was co-analyzed by differential scanning calorimetry and by in situ temperature dependent x-ray diffraction using the identical heating rates. The data for both measurements are shown in FIG. 4. The x-ray plot in FIG. 4, left, is an intensity map of angle versus diffracted intensity. It covers approximately 4 degrees of two-theta space that spans the 111 reflection for J14. At a temperature interval between 825° C. and 875° C., there is a distinct transition to single-phase rocksalt structure. FIG. 4, right, contains the companion calorimetric result—a pronounced endotherm in the identical temperature window. An endothermic response only occurs when the system adds heat to the sample, which is uniquely consistent with an entropy driven transformation.

Thus far, all experiments support the entropic stabilization hypothesis, but they require on an underlying assumption of homogeneous cation mixing. It is conceivable that local compositional fluctuations which lead to coherent clustering or coherent phase separations are present, but invisible to diffraction. While the phase diagram analysis in FIG. 3 supports the homogeneity assumption; the most stable composition is equimolar. This condition is only expected for a regular solution. To corroborate experimentally the random cation distributions, X-ray absorption fine structure (XAFS) and scanning transmission electron microscopy with in situ energy dispersive x-ray spectroscopy (STEM EDS) were used to analyze structure and chemistry on the local scale.

By probing their respective absorption edges, XAFS allows one to measure individually the local coordination of each element. Contrast in cation-to-anion bond lengths that must accompany local clustering, if present, will be visible to XAFS analysis. Alternatively, if the solution is homogeneous on the scale of a few nanometers (the sensitivity range for XAFS), the cation-to anion bond lengths will be uniform.

FIG. 5 shows the XAFS data collected for Zn, Ni, Cu, and Co at the Advanced Photon Source 12-BM. Mg is not shown because its absorption edge was below the available energy range of the beamline. The most important information that can be inferred from these data is that the cation-to-anion first near neighbor distances are identical (to within experimental error) and the general shapes of the XAFS data are qualitatively similar over a range spanning multiple near neighbors. Both observations are consistent with a locally homogeneous material.

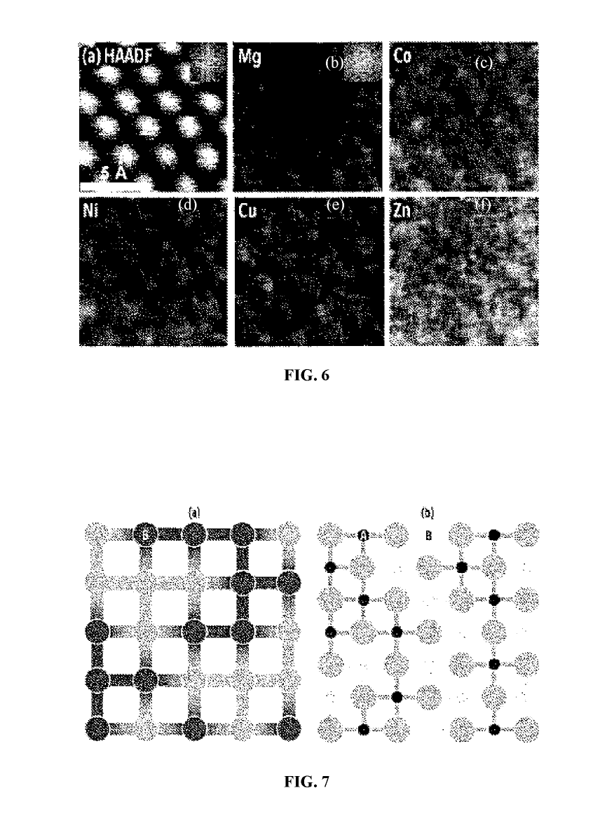

As a final measure of local homogeneity, chemical analysis was conducted using a probe-corrected FEI Titan STEM with EDS detection. The sample was thinned by mechanical polishing and ion milling. FIG. 6 shows a collection of images including 6, image (a), the high-angle annular dark field signal (HAADF). In FIG. 6, images (b)-(f), the EDS signals for the K-edge energies of Mg, Co, Ni, Cu, and Zn are shown. All magnifications reveal chemically and structurally homogeneous material. It is noted in particular that the EDS maps show uniform spatial distributions for each element and are atomically resolved. With this result it is possible to conclude that each column contains a uniform distribution of each cation. X-ray diffraction, XAFS, and STEM-EDS probes are sensitive to 10 s of nm, 10 s of Å, and 1 Å length-scales respectively. Consequently, it may be concluded with certainty that cation distributions are uniform and random. The combination of reversible near-equilibrium annealing studies, compositionally modified configurational entropy experiments, calorimetry, and atomically resolved chemical characterization supports the hypothesis that configurational disorder can promote unexpected solid solubility and a single-phase microstructure.

In the context of five-component high entropy alloy systems, where the relative roles of entropy and mixing enthalpy are a matter of ongoing discussion, the present results appear less challenging to interpret. The clear and pronounced impact of entropy in the case of oxides may seem initially surprising considering that on a per-atom basis the total disorder of an oxide might be lower, as the anion sublattice is completely ordered. The inventors believe, however, that this is not the case. On the contrary, an ordered sublattice may be the key to harnessing maximum configurational entropy. Consider the case of a two-component mixture A-B. If the mixture is ideal, the interactions A-A, B-B, and A-B are identical. There is no enthalpic preference for bonding, and entropy regulates solution formation. This situation, however, never occurs. No two elements have identical electronegativity and radii values. This is particularly true for transition metals with un-filled d-orbitals, incompletely screened S electrons, and mild covalent character. Consequently, there will always be a finite preference for a particular near neighbor. This situation is illustrated in FIG. 7, schematic a, where B is, for example, more electronegative than A. The 20 local electron densities of each metal atom will depend on the specific distributions of first near neighbors. The criterion tantamount to configurational disorder is lost. The system no longer has a distribution of unique species on a set of identical lattice sites, and the number of equivalent microstates falls.

Consider the same two metallic elements co-populating a cation sublattice, as illustrated in FIG. 7, schematic b. In this case, elemental contrast remains, but is screened by anions. Each metal sees the same immediate environment, the interior of an oxygen polyhedron.

This crystallographic argument underpins the hypothesis that anion screening mediates elemental contrast that otherwise leads to preferential near neighbor associations and erodes the ability for entropic stabilization. The anion screening will have limits. However it is likely to expand the elemental diversity containable in a single solid solution and to lower the temperature at which the transition to entropic stabilization occurs.

Entropic stabilization is generic to any system where near-neighbor interactions can be screened. Consequently, the same trends will evolve in broad classes of chalcogenides, nitrides, and halides, particularly when covalent character is modest. The entropic driving force—engineered by cation composition—provides a departure from the crystalochemical principles that so elegantly predict structural trends in the major ternary and quaternary systems. As such, the community is likely to uncover a companion set of structure-property relationships for entropy-stabilized structures, where cations are incorporated in completely new ways. Transformative opportunities for new advanced materials populate this entropic frontier.

It will be understood that various aspects or details of the invention may be changed without departing from the scope of the invention. Furthermore, the foregoing description is for the purpose of illustration only, and not for the purpose of limitation-the invention being defined by the claims.

What is claimed is:

1. A composition, comprising: an equimolar formulation of three or more ionic or partially ionic compounds stabilized by configurational entropy into a homogeneous crystal.

2. The composition of claim 1, wherein the three or more ionic or partially ionic compounds comprise binary compounds, tertiary compounds, and/or quaternary compounds.

3. The composition of claim 1, wherein the equimolar formulation comprises five or more ionic or partially ionic compounds.

4. The composition of claim 1, wherein the equimolar formulation comprises five ionic or partially ionic compounds.

5. The composition of claim 1, wherein the ionic or partially ionic compounds comprise oxides and/or nitrides.

6. The composition of claim 1, wherein the ionic or partially ionic compounds comprise five binary oxides.

7. The composition of claim 6, wherein the binary oxides comprise at least one of: magnesium oxide (MgO), cobalt oxide (CoO), nickel oxide (NiO), copper oxide (CuO), zinc oxide (ZnO), iron oxide (Fe₂O₃), and titanium oxide (TiO₂).

8. The composition of matter of claim 6, wherein the five binary oxides comprise magnesium oxide (MgO), cobalt oxide (CoO), nickel oxide (NiO), copper oxide (CuO), and zinc oxide (ZnO).

9. The composition of matter of claim 6, wherein the five binary oxides comprise magnesium oxide (MgO), iron oxide (Fe₂O₃), zinc oxide (ZnO), copper oxide (CuO), and titanium oxide (TiO₂).

10. The composition claim 1, wherein the equimolar formulation is a single-phase solid solution.
